(19) United States
(12) Patent Application Publication
(10) Pub. No.: US 2005/0257455 A1
(43) Pub. Date: Nov. 24, 2005

(54) Wood-plastic composite door jamb and brickmold, and method of making same

(76) Inventor: Gary T. Fagan, Charlotte, NC (US)

Correspondence Address: BERENATO, WHITE & STAVISH, LLC, 6550 ROCK SPRING DRIVE, SUITE 240, BETHESDA, MD, 20817, US

(21) Appl. No.: 11/080,982

(22) Filed: Mar. 16, 2005

Related U.S. Application Data
(60) Provisional application No. 60/553,556, filed on Mar. 17, 2004.

(51) Int. Cl. E06B 1/04

(52) U.S. Cl. 52/210

(57) ABSTRACT

A building frame member for installation in an opening formed in a wall of a building structure capable of receiving and supporting a door is provided. The building frame member includes a composite of a solid thermoplastic material and wood flour. Preferably, the building frame member includes a thermoplastic skin at least partially covering a core of the composite. The building frame members are particularly useful for serving as doorjambs and/or brickmolds. A building passageway structure having the building frame member, and related methods also are provided.

### CROSS-REFERENCE TO RELATED APPLICATION(S)

This application claims the benefit of priority of provisional application Ser. No. 60/553,556 filed Mar. 17, 2004, the complete disclosure of which is incorporated herein by reference.

### BACKGROUND OF THE INVENTION

1. Field of the Invention

The present invention relates to building frame members, especially jambs and/or brickmolds useful in combination with door structures. The present invention further relates to building passageway structures comprising building frame members, and to related methods for making the building frame members and building passageway structures.

2. Description of Related Art

Door passageway structures in buildings typically comprise an opening defined at its periphery by a building wall. The building wall typically comprises at the opening periphery some type of wood or metal studs, although the wall may be formed of other building materials, such as brick, concrete, etc. A prefabricated frame is mounted on the wall along the periphery of the opening. In the case of a door structure, the frame typically comprises a pair of spaced vertical doorjambs defining the sides of the prefabricated frame, and a header jamb extending between the tops of the vertical doorjambs to define the top of the doorframe. Typically a sill structure extends between the jambs at the lower ends thereof. Generally, a door is mounted (often using hinges) to one of the doorjambs, also referred to herein as the hinge side doorjamb, to permit movement of the door between open and closed positions for selective accessibility to the building interior. The opposite side doorjamb, also referred to herein as the latching-side doorjamb, usually comprises a stop portion that the door abuts when in the closed position. The stop portion, which typically also is present on the header and hinge-side doorjambs, prevents the door from swinging completely through the door opening.

The doorframe optionally further comprises a brickmold, which conceals the interface between the doorjamb and the exterior wall surface at the opening. The brickmold serves a decorative function and also minimizes air and water infiltration between the doorframe and the building. The brickmold may be fabricated separately from the doorjamb.

Doorjambs and brickmolds have traditionally been fabricated from wood, steel, polymers and the like. Although wood provides a very satisfying aesthetic appearance, it is prone to rotting, cracking and splitting. For these and other reasons, the door industry has looked to other materials for fabricating doorframes. For example, polystyrene has been extruded in the form of solid or hollow jambs and brickmolds. However, exclusively plastic framing components sometimes lack the aesthetic and physical properties of wood, lack suitable paintability characteristics, and possess poor screw retention. Further, pure polymer components are expensive and often have unsatisfactory expansion characteristics. For these reasons, many builders and remodelers find polymeric framing components objectionable.

### SUMMARY OF THE INVENTION

It is therefore an object of the present invention to provide a framing member that overcomes the above-discussed problems and is suitable for use as a jamb, brickmold, or the like of a building passageway structure, such as a door assembly.

In accordance with the purposes of the invention as embodied and described herein, a first aspect of the invention provides a building frame member for installation in an opening formed in a wall of a building structure to receive and support a door. The frame member comprises a composite core coextruded with and encased in (or partially covered with) a thermoplastic skin, the composite core comprising a solid thermoplastic material and wood flour, and optionally additives.

According to a second aspect of the invention, a building frame member is provided for installation in an opening formed in a wall of a building structure to receive and support a door. The frame member comprises a composite comprising a solid thermoplastic material, wood flour, and optionally additives. The composite optionally serves as a core component of the frame member.

According to a third aspect of the invention, a building passageway structure is provided. The building passageway structure comprises a wall and a plurality of frame members. The wall comprises opposite first and second vertical wall sides, a top horizontal wall, and optionally a bottom horizontal wall collectively defining a passageway opening sized and shaped for receiving a doorframe. The frame members comprise spaced vertical side frame members mounted on the first wall side and second wall side, respectively, a horizontal header frame member mounted on the wall top extending between the side frame members, and optionally a horizontal sill member mounted on the wall bottom extending between the side frame members. The frame members comprise a composite core coextruded with and encased in (or partially covered with) a thermoplastic skin, the composite core comprising a solid thermoplastic material, wood flour, and optionally additives.

According to a fourth aspect of the invention, a method is provided for making a building frame member using a coextrusion process.

The present invention is useful in combination with various door structures, including single and multiple (e.g., double) door passageways. The building passageway frame members of the various aspects of the present invention preferably comprise jambs, such as doorjambs, but may also comprise other members and door components, such as brickmolds, mullions, astragals, etc.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 is a cross-sectional view of a doorjamb attached to a wall according to a first embodiment of the invention;

FIG. 2 is a perspective view of a building doorway structure comprising the wall and doorjamb of FIG. 1;

FIG. 3 is a cross-sectional view of a passage structure comprising a doorjamb and a brickmold attached to a wall according to a second embodiment of the invention;

FIG. 4 is a flowchart of a process for making a jamb and/or brickmold according to an embodiment of the invention; and

FIG. 5 is a side sectional view of a portion of a doorjamb according to another embodiment of the invention.

### DETAILED DESCRIPTION OF PREFERRED EMBODIMENTS AND METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

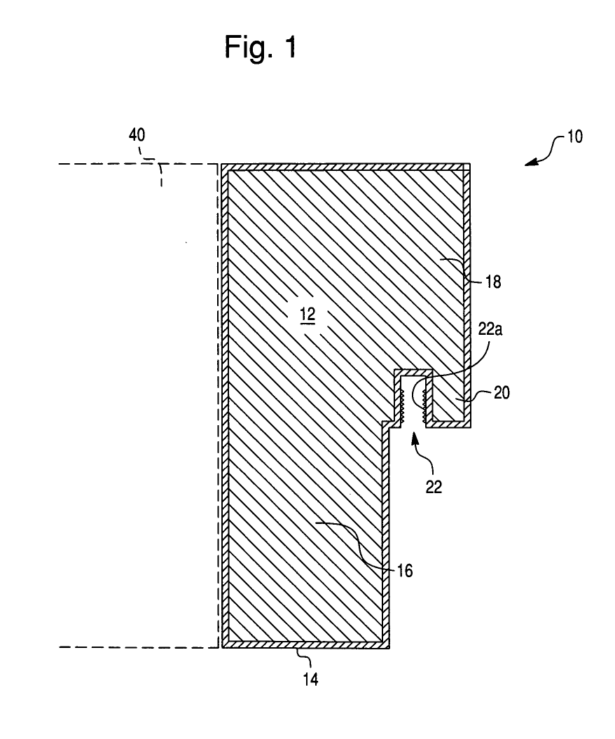

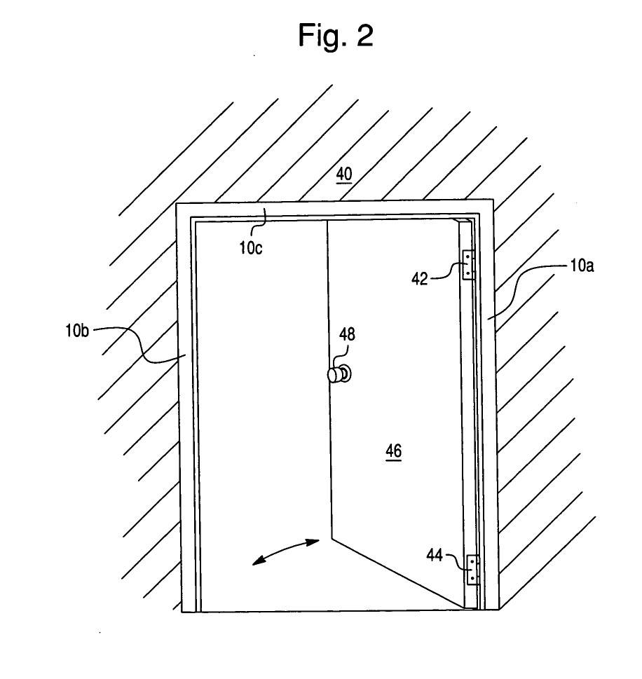

Referring now more particularly to the drawings, and in particular FIG. 1, there is shown in cross section a frame member comprising a doorjamb 10 according to an embodiment of the invention. The doorjamb 10 is shown mounted on a wall structure 40. As better shown in FIG. 2, the doorjamb 10 comprises a vertical hinge-side doorjamb component 10a mounted on the first side of the wall structure 40, a vertical latch-side doorjamb component 10b mounted on the second side of the wall structure 40 and opposing the vertical hinge-side doorjamb component 10a, and a horizontal header doorjamb component 10c mounted on the top of the wall structure 40 and extending between the side doorjamb components 10a and 10b. The doorjamb components 10a, 10b, and 10c may be fabricated as a plurality (e.g., three) of separate pieces which are joined together by suitable fasteners, adhesive or the like. The doorjamb may be preassembled or assembled on site.

The wall structure 40 comprises an opening-defining periphery typically but not necessarily made of wood or metal studs, such as elongated 2″×4″ studs. Any suitable means may be used to connect the doorjamb 10 to the wall structure 40, including for example mechanical fasteners (e.g., screws, nails, bolts, clips, etc.), chemical bonding, or the like. The doorjamb components 10a, 10b, and 10c may be mounted as a single unitary piece or as a plurality of separate pieces. Although not shown, those skilled in the art will recognize that a sill member typically will extend between doorjamb members 10a and 10b at their lower ends, in order to provide a threshold.

Hinges 42 and 44 pivotally join a door 46 to the vertical hinge-side doorjamb component 10a. Standard hinge fasteners, such as screws and the like, may be used for mounting. Although not shown, the doorknob 48 may include a latching and/or locking mechanism operatively cooperating with the vertical latch-side doorjamb component 10b for retaining and optionally selectively locking the door 46 in a closed position. The door 46 preferably is an exterior door, such as manufactured from fiberglass/polymer composite, steel, and the like.

The doorjamb 10 of the first illustrated embodiment comprises in cross section a substantially rectangular base portion 16 and a stop portion 18 integrally formed with one another as a unitary, homogenous structure, as best shown in FIG. 1. The stop portion 18 comprises a leg 20 spaced from the base portion 16 to define a groove 22 optionally having opposing side surfaces 22a. The groove 22 is sized to receive a length of weather stripping, sealant strip, elastic material, etc. and to capture the same with the side surfaces 22a. When mounted on the wall structure 40, movement of the door 46 into its closed position abuts the interior periphery of the door 46 against the stop portion 18 of the doorjamb 10, preventing the door 46 from swinging completely through the passage opening.

The doorjamb 10 comprises a composite core 12 and a polyvinylchloride (PVC) skin 14 coextruded with the composite core 12. In the illustrated embodiment, the skin 14 is shown encasing the core 12. It is to be understood that a portion (e.g., one, two, or more sides) of the core 12 optionally may be exposed or otherwise not covered with the skin 14. The thickness of the composite core 12 may be varied depending upon the intended use, including the size and loads placed on the associated door 46. The skin 14 preferably has a thickness of about 10 mils (0.010 inches) to about 40 mils (0.040 inches), optionally about 10 mils to about 20 mils (0.020 inches).

The composite core 12 comprises wood flour and a solid thermoplastic. The wood flour preferably comprises particles or powder having a mesh size of 60-120. Wood flour having this preferred mesh size has been found to improve dispersibility of the wood flour. The wood flour may be prepared from softwood, hardwood, a combination thereof, or any other natural fibers, such as bamboo kenaf, rice husks, etc. Wood flour of this preferred mesh size is commercially available. The wood flour is preferably relatively fine to increase the surface area available for bonding to the solid thermoplastic and for enhancing foaming. Fine wood flour is somewhat more difficult to process as compared with more common sizes of 20 mesh or so, and is more expensive than those large sizes. The finer size when foamed achieves a suitable composite that has acceptable screw retension, thermal expansion, and density properties, however. The resulting density is substantially the same as the density of wood, thus achieving a more natural end product. Larger size wood flour in my experience has poor foaming capabilities.

Representative solid thermoplastics that may be included in the composite core are compatible or capable of compatibility with the skin 14, and include acrylonitrile-butadiene-styrene (ABS), ABS blends, and/or polypropylene. I prefer that thermoplastic materials be used, to permit recycling of the polymer as a further means of minimizing costs. The polymer need not be virgin material and preferably contains a substantial percentage of scrap or recovered thermoplastic material.

Preferably, the wood flour is homogenously dispersed in the solid thermoplastic of the composite core 12. According to an embodiment, the wood flour constitutes from about 30 to about 60 weight percent of the total weight of the composite core 12, more preferably about 40 to about 50 weight percent, for enhancing thermal properties of the resulting material and improving stiffness of the core 12. In the same embodiment, the solid thermoplastic constitutes from about 40 to about 70 weight percent of the total weight of the composite core 12, more preferably about 50 to about 60 weight percent. The wood flour material preferably is a ground material and the particles typically (but optionally) are not spherical.

The composite core 12 may include other ingredients and fillers. For example, foaming agents are particularly advantageous for providing the composite core 12 with porosity and lowering the overall density of the core 12. Preferably, the foaming agents, if any, are included in an amount to provide the composite core 12 with a density similar to that of natural wood. By way of example and not necessarily limitation, the composite core 12 may comprise approximately 0.4 weight percent foaming agent. Another example of an additional ingredient of the composite core 12 comprises coupling agents for improving the compatibility, e.g., adhesion, between the wood flour and the solid thermoplastic. An example of a preferred coupling agent is maleated polypropylene or titanate materials may be present, for example, in an amount of 1 to 3 weight percent, more preferably approximately 1.0 weight percent or less based on the total weight of the composite core 12.

The composite core 12 preferably is free or substantially free of fusion enhancers, oxidized polyolefins (e.g., oxidized polyethylene), and/or PVC.

The skin 14 preferably comprises virgin PVC and optionally other ingredients, such as UV stabilizers to provide protection against prolonged exposure to UV light. Virgin PVC is preferred because the jamb components are observable to users and therefore must be aesthetically pleasing. Other thermoplastics such as polypropylene may also be selected, although preferably a surface treatment will be applied to enhance paint holding capacity. The skin 14 is preferably compatible with commercially available paints and/or primers for enhancing the aesthetic appearance of the doorjamb 10. According to a preferred embodiment, the skin 14 is capable of including pigments (such as TiO₂) for providing a selected color to the outer surface of the skin 14. The doorjamb therefore may be “prefinished.”

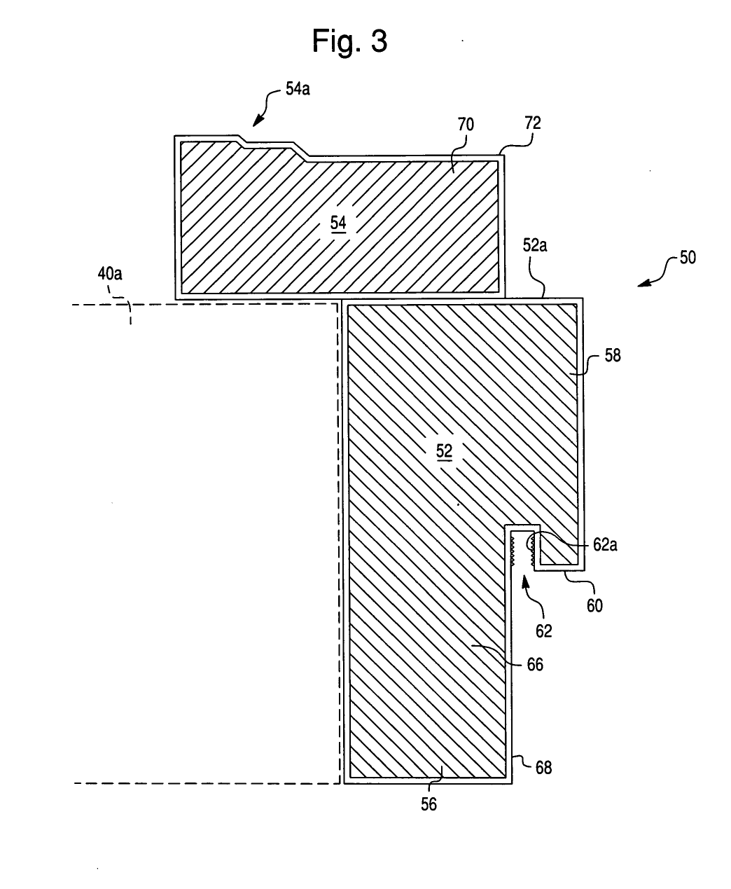

A frame member in accordance with a second embodiment of the invention is generally designated in FIG. 3 by reference numeral 50. The frame member 50 comprises a doorjamb 52 mounted on the opening-defining edge of the wall structure 40A. The doorjamb 52 has an edge 52a.

The doorjamb 52 comprises a substantially rectangular base portion 56 and a stop portion 58 integrally formed with one another as a unitary, homogenous structure. The stop portion 58 comprises a leg 60 spaced apart from the base portion 56 to define a groove 62 optionally having opposing side surfaces 62a. The groove 62 is sized to receive a length of weather stripping, sealant strip, elastic material, etc. and to capture the same with the side surfaces 62a. When mounted on the wall structure 40A, movement of the door into its closed position abuts the periphery of the door against the stop portion 58 of the doorjamb 52, assisting to prevent the door from swinging completely through the passage opening.

The frame member 50 further comprises a brickmold 54 mounted to the doorjamb 52 and/or the wall structure 40A using a suitable attachment means, such as a mechanical fastener (e.g., nail, screw, etc.) or chemical bonding agent. In the illustrated embodiment, the brickmold 54 overlies a portion of the outside edge 52a of the doorjamb 52 and a peripheral portion of the wall structure 40A. The brickmold 54 extends along the length of the doorjamb 52 adjacent the outside edge 52a of the doorjamb 52 for framing the doorjamb 52 on the outside of a building structure 40A. (Although not shown, it should be understood that the brickmold 54 may also or alternatively overly a portion of the inside edge 52b of the doorjamb 52.) The brickmold 54 comprises an external face that is optionally decorative, as emphasized in FIG. 3 by contoured face 54a.

The doorjamb 52 comprises a composite core 66 and a thermoplastic (e.g., polyvinylchloride (PVC)) skin 68 coextruded with and encasing the composite core 66. The brickmold 54 similarly comprises a composite core 70 and a thermoplastic (e.g., polyvinylchloride (PVC)) skin 72 coextruded with and encasing the composite core 70. The composite cores 66 and 70 comprise materials, properties, dimensions, etc. as described above in connection with the description of core 12. The skins 68 and 72 comprise materials, properties, dimensions, etc. as described above in connection with the description of skin 14.

Modifications and variations to the configurations and relationships of the doorjamb and brickmold will be apparent to skilled artisans having reference to this disclosure. For example, the doorjamb and brickmold may be made as a unitary piece. Further, it is to be understood that the present invention encompasses embodiments in which only one of the doorjamb or brickmold comprise a composite core and encasing PVC skin. Furthermore, although the frame members have been illustrated as doorjambs and door brickmolds, it is to be understood that the frame members may be used for other purposes, including other building structures. The frame members of the present invention are useful in both commercial and residential building structures.

The frame members of the present invention possess excellent high impact properties. According to the preferred embodiments, the frame members are able to pass the forced entry test of ASTM F-476.

The frame members of the present invention also possess excellent screw retention properties. According to the preferred embodiments, the frame members have screw retention properties equal or superior to pine wood. As tested using a ¾-inch #9 screw and an Instron measurement instrument, embodiments of the frame members have been shown to require 200 lb for screw removal.

The frame members of embodiments of the present invention further possess excellent coefficients of thermal expansion, preferably throughout a range of −20° F. to 160° F., and occasionally peak temperatures of 240° F. or greater at the top of the door. The frame members of embodiment of the invention also possess excellent paintability.

An embodiment of a method for making the frame members of the present invention will now be described in detailed. It is to be understood that the scope of the invention is not necessarily limited to frame members made by the method described below.

According to an embodiment of the present invention, a method is provided for making the frame members. The method comprises extruding a composite core comprising wood flour and a solid thermoplastic into a homogenous state, and extruding a skin (e.g., polyvinylchloride (PVC)) to encase the composite core.

The extrusion steps may be performed in any suitable extruder, including single-screw extruders and twin-screw extruders comprising co-rotating screws or counter-rotating screws.

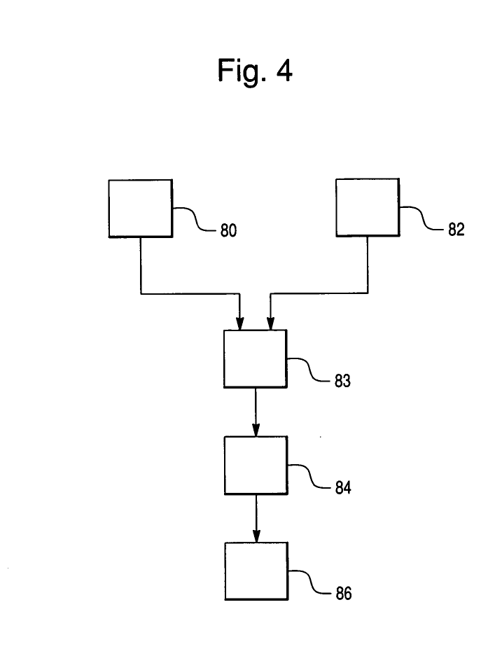

Referring to FIG. 4, there is shown a first extruder 80 in which the composite core is extruded. The wood flour and thermoplastic may be introduced into the first extruder 80 together or separately, and optionally may be premixed prior to their introduction in the first extruder 80. Likewise, other ingredients, such as foaming and coupling agents, may be introduced together with or separately from the wood flour and thermoplastic. The various ingredients may be introduced into the same zone of the first extruder 80 or in separate zones that are upstream/downstream from one another. Preheating of the ingredients is optional.

The first extruder 80 is operated at a temperature sufficiently high to melt the thermoplastic, but not so high as to thermally degrade the thermoplastic or the wood flour. The operating temperature will depend upon the thermoplastic selected. For example, in the case ABS (e.g., virgin, scrap, and/or reground) is selected as the thermoplastic, a suitable operation temperature range is between 250° F. to 325° F. The zones may operate at different temperatures from one another, for example, decreasing in temperature downstream. Preferably but optionally, the temperature at which the first extruder 80 is operated is sufficiently high to drive moisture out of the wood flour, which typically has an initial moisture content of 8% or more, so that the composite core of the resulting product has a moisture content of less than 1 weight percent. The screw or screws of the first extruder 80 preferably are operated at speeds and torques sufficient to produce a homogeneous or substantially homogeneous dispersion of wood flour in the thermoplastic. The flow rate preferably is about 1200 lbs/hr.

A second extruder 82 is simultaneously operated to extrude the skin. The feed preferably comprises, and optionally essentially consists of, virgin PVC. UV stabilizers and other ingredients may be added, preferably in small amounts. The operating temperature may range from above the melting temperature to below the degradation temperature of PVC.

Material streams exiting the first and second extruders 80 and 82 are fed into a coextrusion die 83 to encase the composite wood flour/composite core in the PVC skin. The coextruded streams are then fed to a sizer die 84, and thereafter subject to cooling, for example, in a cooling tank or spray 86. Optionally, the method may further comprise subjecting the cooling skin to texturizing, such as with an embossing roller or rollers. The brick mold 50, for example, may be provided with a wood grain pattern along its three exteriorly exposed surfaces in order to more accurately resemble wood.

The frame members and building passageway structures of the present invention provide various advantages. For example, according to some embodiments the frame member, e.g., doorjamb, may include a pigment or external paint to provide the frame member with a prefinished look, that requires no more than minor touch-ups subsequent to installation. According to various embodiments, the frame member has a cost relatively close to that of natural wood, while avoiding rotting problems associated with wood. Embodiments of the invention provide frame members having excellent physical properties, including dimensional stability.

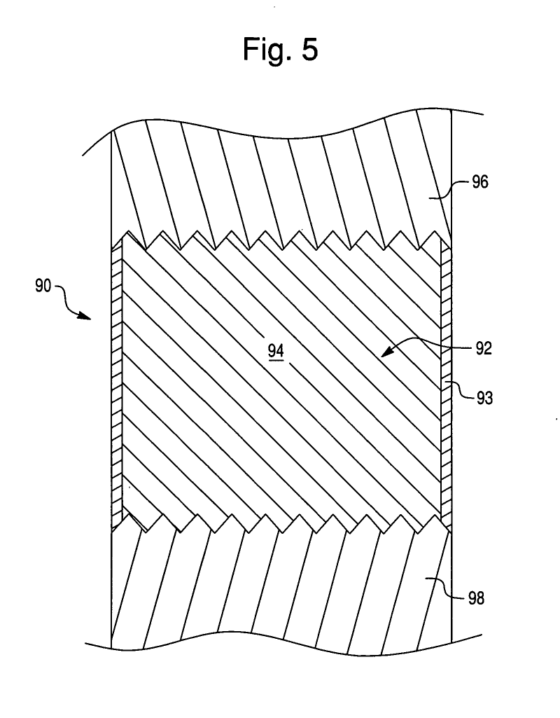

These and other advantages of the present invention make the frame member of the present invention useful in a number of different applications and settings. For example, FIG. 5 shows an embodiment in side sectional view wherein a frame member 90 comprises a component 92 of an embodiment of the invention attached to one, two, or more conventional components 96 and 98, such as solid wood or plastic components. In the illustrated embodiment, the component 92 has opposite ends finger jointed to conventional components 96 and 98, respectively. It should be understood that attachment techniques other than finger joints are possible. The component 92 comprises a composite core 94 (same as 12 and 66 above) and a skin 93 (same as 14 and 68 above). Due to the excellent physical properties (e.g., screw retention) of the materials of the present invention, the component 92 is especially suited for use as part of a doorjamb, for example, at locations along the doorway frame where a hinge or latching member is attached.

Additional advantages and modifications will readily occur to those skilled in the art upon reference to this disclosure. Therefore, the invention in its broader aspects is not limited to the specific details, representative devices and methods, and illustrative examples shown and described. Accordingly, departures may be made from such details without departing from the spirit or scope of the general inventive concept.

1. A building frame member for installation in an opening formed in a wall of a building structure capable of receiving and supporting a door, comprising:
a composite comprising a solid thermoplastic material and wood flour.

2. The building frame member of claim 1, comprising:
a thermoplastic skin coextruded with and at least partially covering a composite core, the composite core comprising the composite.

3. The building frame member of claim 2, wherein the thermoplastic skin encases the composite core.

4. The building frame member of claim 2, wherein the thermoplastic skin comprises polyvinylchloride.

5. The building frame member of claim 2, wherein the solid thermoplastic material of the composite core comprises a member selected from acrylonitrile-butadiene-styrene (ABS), ABS blends, polypropylene, and combinations thereof.

6. The building frame member of claim 2, wherein the wood flour has a mesh size of 60 to 120.

7. The building frame member of claim 2, wherein the wood flour constitutes from about 30 to about 60 weight percent of the total weight of the composite core, and wherein the solid thermoplastic material constitutes from about 40 to about 70 weight percent of the total weight of the composite core.

8. The building frame member of claim 2, wherein the wood flour constitutes from about 40 to about 50 weight percent of the total weight of the composite core, and wherein the solid thermoplastic material constitutes from about 40 to about 50 weight percent of the composite core.

9. A building passageway structure, comprising:
a building wall comprising opposite first and second wall sides, and a horizontal wall top extending between the wall sides, the building wall providing a passageway opening; and
a doorframe situated at the passageway opening, the doorframe comprising spaced vertical first and second side frame members mounted on the first wall side and the second wall side, respectively, and a horizontal header frame member mounted on the wall top and extending between the first and second side frame members, the frame members comprising a composite comprising a solid thermoplastic material and wood flour.

10. The building passageway structure of claim 9, wherein the frame members comprise a thermoplastic skin coextruded with and at least partially covering a composite core, the composite core comprising the composite.

11. The building passageway structure of claim 10, wherein the thermoplastic skin encases the composite core.

12. The building passageway structure of claim 10, wherein the thermoplastic skin comprises polyvinylchloride.

13. The building passageway structure of claim 10, wherein the solid thermoplastic material of the composite core comprises a member selected from acrylonitrile-butadiene-styrene (ABS), ABS blends, polypropylene, and combinations thereof.

14. The building passageway structure of claim 10, wherein the wood flour has a mesh size of 60 to 120.

15. The building passageway structure of claim 10, wherein the wood flour constitutes from about 30 to about 60 weight percent of the total weight of the composite core, and wherein the solid thermoplastic material constitutes from about 40 to about 70 weight percent of the total weight of the composite core.

16. The building passageway structure of claim 10, wherein the wood flour constitutes from about 40 to about 50 weight percent of the total weight of the composite core, and wherein the solid thermoplastic material constitutes from about 40 to about 50 weight percent of the composite core.

17. The building passageway structure of claim 10, wherein the frame members each comprise a respective doorjamb facing inward toward the passageway opening.

18. The building passageway structure of claim 17, further comprising:
a door pivotally connected to the first side frame member, the door comprising a first latching mechanism for cooperating with a second latching mechanism mounted on the second side frame member.

19. The building passageway structure of claim 10, further comprising:
first and second side doorjambs mounted on the first wall side and the second wall side, respectively, and a horizontal header doorjamb mounted on the wall top and extending between the first and second side doorjambs,
wherein the first and second side frame members and the header frame member comprise first and second side brickmolds and a header brickmold, respectively, the first brickmold overlies a first interface of the first wall side and the first side doorjamb, the second brickmold overlies a second interface of the second wall side and the second side doorjamb, and the header brickmold overlies a third interface of the wall top and the header doorjamb.

20. The building passageway structure of claim 19, wherein the doorjambs comprise a composite core coextruded with and at least partially covered with a thermoplastic skin, the composite core comprising a solid thermoplastic material and wood flour.

21. A method of making a building frame member, comprising:
coextruding a composite core and a thermoplastic skin at least partially covering the composite core, the composite core comprising a thermoplastic material and wood flour.
